(19) United States
(12) Patent Application Publication
(10) Pub. No.: US 2022/0404587 A1
(43) Pub. Date: Dec. 22, 2022

(54) OPTICAL IMAGING LENS

(71) Applicant: Calin Technology Co., Ltd., Taichung City (TW)

(72) Inventor: YUNG-CHIEH TSENG, Taichung City (TW)

(73) Assignee: Calin Technology Co., Ltd., Taichung City (TW)

(21) Appl. No.: 17/397,325

(22) Filed: Aug. 9, 2021

(30) Foreign Application Priority Data
Jun. 22, 2021 (TW) 110122720

(51) Int. Cl. G02B 13/00; G02B 9/60; G02B 27/00

(52) U.S. Cl. CPC G02B 13/0045; G02B 9/60; G02B 27/0025

(57) ABSTRACT

An optical imaging lens, in order from an object side to an image side along an optical axis, includes a first lens, a second lens, an aperture, a third lens, a fourth lens, and a fifth lens. The first lens has negative refractive power. The second lens has positive refractive power. The third lens is a biconvex lens with positive refractive power. The fourth lens is a biconcave lens with negative refractive power. The fifth lens has positive refractive power. The optical imaging lens satisfies: −0.55≤f345/f12≤−0.35, wherein f12 is a focal length of a combination of the first lens and the second lens, and f345 is a focal length of a combination of the third lens, the fourth lens, and the fifth lens.

### BACKGROUND OF THE INVENTION

### Technical Field

The present invention generally relates to an optical image capturing system, and more particularly to an optical imaging lens.

### Description of Related Art

In recent years, with advancements in portable electronic devices having camera functionalities, the demand for an optical image capturing system is raised gradually. The image sensing device of the ordinary photographing camera is commonly selected from a charge-coupled device (CCD) or a complementary metal-oxide-semiconductor sensor (CMOS Sensor). Besides, as advanced semiconductor manufacturing technology enables the minimization of the pixel size of the image sensing device, the development of the optical image capturing system towards the field of high pixels. Moreover, as the image quality of the automotive lens changes with the temperature of an external application environment, the temperature requirements of the automotive lens also increase. Therefore, the requirement for high imaging quality is rapidly raised.

However, conventional optical imaging lenses can no longer meet the existing needs. Therefore, how to provide an optical imaging lens that could effectively reduce aberrations and improve the quality of optical imaging has become a major issue in the industry.

### BRIEF SUMMARY OF THE INVENTION

In view of the reasons mentioned above, the primary objective of the present invention is to provide an optical imaging lens that provides a better optical performance of high image quality and low distortion.

The present invention provides an optical imaging lens, in order from an object side to an image side along an optical axis, including a first lens having negative refractive power, a second lens having positive refractive power, an aperture, a third lens having positive refractive power, a fourth lens having negative refractive power, a fifth lens having positive refractive power, wherein an object-side surface of the first lens is a convex surface, and an image-side surface of the first lens is a concave surface. The object-side surface of the first lens and/or the image-side surface of the first lens are/is an aspheric surface. An object-side surface of the second lens is a concave surface, and an image-side surface of the second lens is a convex surface, wherein the object-side surface of the second lens and/or the image-side surface of the second lens are/is an aspheric surface. The third lens is a biconvex lens, wherein an object-side surface of the third lens and/or an image-side surface of the third lens are/is an aspheric surface. The fourth lens is a biconcave lens, wherein an object-side surface of the fourth lens and/or an image-side surface of the fourth lens are/is an aspheric surface. An object-side surface of the fifth lens is a convex surface, and an image-side surface of the fifth lens is a concave surface, wherein the object-side surface of the fifth lens and/or the image-side surface of the fifth lens are/is an aspheric surface. The optical imaging lens satisfies: −0.55≤f345/f12≤−0.35, wherein f12 is a focal length of a combination of the first lens and the second lens, and f345 is a focal length of a combination of the third lens, the fourth lens, and the fifth lens.

With the aforementioned design, the optical imaging lens of the present invention could achieve the effect of high image quality and low distortion.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1A is a schematic view of the optical imaging lens according to a first embodiment of the present invention;

FIG. 1B is a diagram showing the field curvature of the optical imaging lens according to the first embodiment of the present invention;

FIG. 1C is a diagram showing the distortion of the optical imaging lens according to the first embodiment of the present invention;

FIG. 1D is a diagram showing the longitudinal spherical aberration of the optical imaging lens according to the first embodiment of the present invention;

FIG. 2A is a schematic view of the optical imaging lens according to a second embodiment of the present invention;

FIG. 2B is a diagram showing the field curvature of the optical imaging lens according to the second embodiment of the present invention;

FIG. 2C is a diagram showing the distortion of the optical imaging lens according to the second embodiment of the present invention; and

FIG. 2D is a diagram showing the longitudinal spherical aberration of the optical imaging lens according to the second embodiment of the present invention.

### DETAILED DESCRIPTION OF THE INVENTION

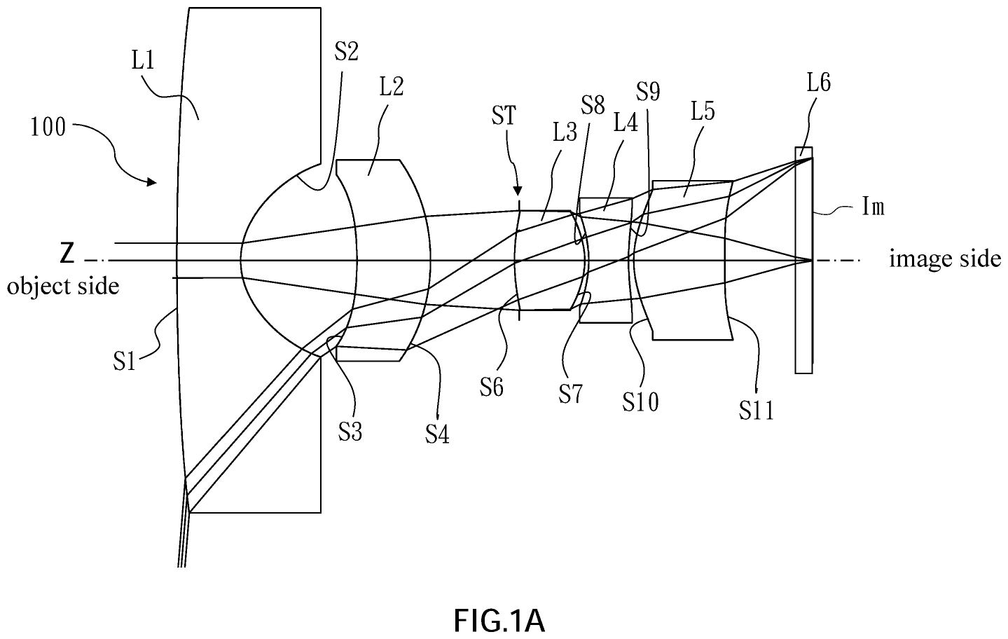

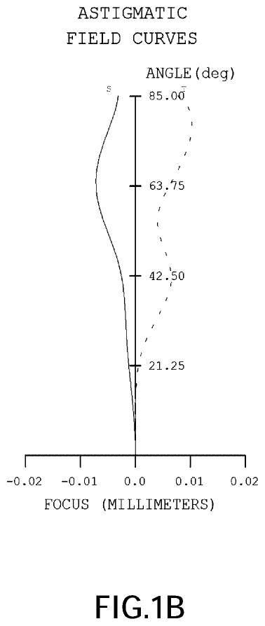

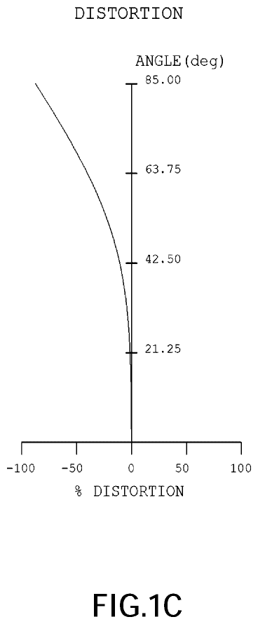

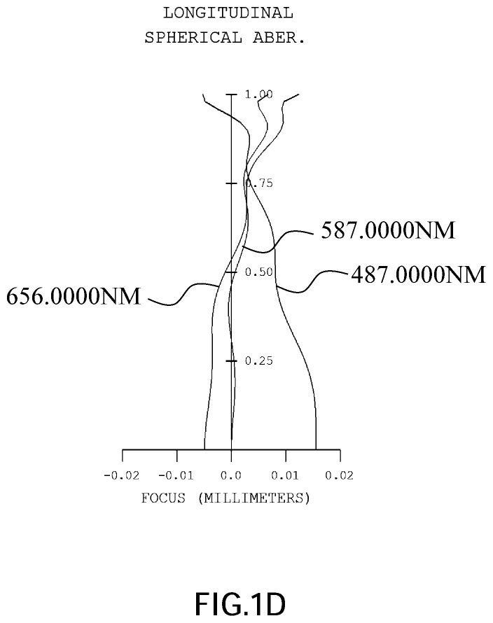

An optical imaging lens 100 according to a first embodiment of the present invention is illustrated in FIG. 1A, which includes, in order along an optical axis Z from an object side to an image side, a first lens L1, a second lens L2, an aperture ST, a third lens L3, a fourth lens L4, and a fifth lens L5.

The first lens L1 is a negative meniscus with negative refractive power, wherein an object-side surface S1 of the first lens L1 is a convex surface that is slightly convex toward the object side, and an image-side surface S2 of the first lens L1 is a concave surface that is arc-shaped. In the current embodiment, a part of a surface of the first lens L1 toward the image side is recessed to form the image-side surface S2, and the optical axis Z passes through both the object-side surface S1 and the image-side surface S2. The object-side surface S1 is an aspheric surface, the image-side surface S2 is an aspheric surface, or both of the object-side surface S1 and the image-side surface S2 of the first lens L1 of the first lens L1 are aspheric surfaces. In the current embodiment, both of the object-side surface S1 and the image-side surface S2 of the first lens L1 are aspheric surfaces.

The second lens L2 is a positive meniscus with positive refractive power, wherein an object-side surface S3 of the second lens L2 is a concave surface that is meniscus shaped, and an image-side surface S4 of the second lens L2 is a convex surface. The object-side surface S3 is an aspheric surface, the image-side surface S4 is an aspheric surface, or both of the object-side surface S3 and the image-side surface S4 of the second lens L2 are aspheric surfaces. In the current embodiment, both of the object-side surface S3 and the image-side surface S4 of the second lens L2 are aspheric surfaces.

The third lens L3 is a biconvex lens with positive refractive power (i.e., an object-side surface S6 of the third lens L3 and an image-side surface S7 thereof are convex surfaces). The object-side surface S6 of the third lens L3 is closer to the aperture ST than the image-side surface S4 of the second lens L2. The object-side surface S6 is an aspheric surface, the image-side surface S7 is an aspheric surface, or both of the object-side surface S6 and the image-side surface S7 of the third lens L3 are aspheric surfaces. In the current embodiment, both of the object-side surface S6 and the image-side surface S7 of the third lens L3 are aspheric surfaces.

The fourth lens L4 is a biconcave lens with negative refractive power (i.e., an object-side surface S8 of the fourth lens L4 and an image-side surface S9 thereof are concave surfaces). The object-side surface S8 is an aspheric surface, the image-side surface S9 is an aspheric surface, or both of the object-side surface S8 and the image-side surface S9 of the fourth lens L4 are aspheric surfaces. In the current embodiment, both of the object-side surface S8 and the image-side surface S9 of the fourth lens L4 are aspheric surfaces.

The fifth lens L5 has positive refractive power, wherein an object-side surface S10 of the fifth lens L5 is a convex surface, and an image-side surface S11 of the fifth lens L5 is a concave surface. The object-side surface S10 is an aspheric surface, the image-side surface S11 is an aspheric surface, or both of the object-side surface S10 and the image-side surface S11 of the fifth lens L5 are aspheric surfaces. In the current embodiment, both of the object-side surface S10 and the image-side surface S11 of the fifth lens L5 are aspheric surfaces.

Additionally, the optical imaging lens 100 further includes an infrared filter L6 disposed at a side of the image-side surface S11 of the fifth lens L5 and located between the fifth lens L5 and an image plane Im of the optical imaging lens 100.

In order to keep the optical imaging lens 100 in good optical performance and high imaging quality, the optical imaging lens 100 further satisfies:

0.1<F/TTL<0.15; (1)

−0.25<F/f12<−0.15; −0.68<F/f1<−0.45; 0.1<F/f2<0.2; (2)

0.35<F/f345<0.5; 0.55<F/f3<0.85; −0.85<F/f4<−0.55; 0.35≤F/f5≤0.45; (3)

−0.55≤f345/f12≤−0.35; −1.5<f4/f3≤−0.85; (4)

wherein TTL is a total length of the optical imaging lens 100 (i.e., a distance on the optical axis Z from the object-side surface of the first lens to the image plane); F is a focal length of the optical imaging lens 100; f1 is a focal length of the first lens L1; f2 is a focal length of the second lens L2; f3 is a focal length of the third lens L3; f4 is a focal length of the fourth lens L4; f5 is a focal length of the fifth lens L5; f12 is a focal length of a combination of the first lens L1 and the second lens L2; f345 is a focal length of a combination of the third lens L3, the fourth lens L4, and the fifth lens L5.

Parameters of the optical imaging lens 100 of the first embodiment of the present invention are listed in following Table 1, including the focal length F of the optical imaging lens 100 (also called an effective focal length (EFL)), a F-number (Fno), a maximal field of view (HFOV), a total length of the optical imaging lens 100 (TTL) (i.e., a distance on the optical axis Z from the object-side surface of the first lens to the image plane), a radius of curvature (R) of each lens, a distance (D) between each surface and the next surface on the optical axis Z, a refractive index (Nd) of each lens, an Abbe number (Vd) of each lens, and the focal length of each lens, wherein a unit of the focal length, the radius of curvature, and the distance is millimeter (mm). The data listed below are not a limitation of the present invention, wherein the parameters that could be appropriate changed by one with ordinary skill in the art after referring the present invention should still fall within the scope of the present invention.

TABLE 1
F = 0.84 mm; Fno = 2.05; HFOV = 170 deg; TTL = 8.0 mm; 1/2 Image height = 1.2 mm

| Surface | R (mm) | D (mm) | Nd | Vd | Focal length | Note |
|---|---|---|---|---|---|---|
| S1 | 34.982 | 0.80 | 1.525 | 56 | −1.558 | L1 |
| S2 | 0.796 | 1.46 | | | | |
| S3 | −3.617 | 0.93 | 1.64 | 23.5 | 6.634 | L2 |
| S4 | −2.156 | 1.12 | | | | |
| ST | | −0.06 | | | | Aperture |
| S6 | 2.152 | 0.88 | 1.525 | 56 | 1.188 | L3 |
| S7 | −0.758 | 0.05 | | | | |
| S8 | −1.083 | 0.50 | 1.64 | 23.5 | −1.088 | L4 |
| S9 | 2.349 | 0.07 | | | | |
| S10 | 1.063 | 1.14 | 1.525 | 56 | 2.057 | L5 |
| S11 | 34.861 | 0.10 | | | | |
| S12 | | 0.21 | 1.516 | 64 | | Infrared filter |
| S13 | | 0.80 | | | | |
| Im | 0 | 0 | | | | |

It can be seen from Table 1 that, in the current embodiment, the focal length F of the optical imaging lens 100 is 0.84 mm, and the Fno of the optical imaging lens 100 is 2.05, and the HFOV of the optical imaging lens 100 is 170 degrees, and the TTL of the optical imaging lens 100 is 8.0 mm, wherein f1=−1.558 mm; f2=6.634 mm; f3=1.188 mm; f4=−1.088 mm; f5=2.057 mm; f12=−4.121 mm; f345=2 mm.

Additionally, based on the above detailed parameters, detailed values of the aforementioned conditional formula in the first embodiment are as follows: F/TTL=0.105; F/f12=−0.203; F/f1=−0.539; F/f2=0.126; F/f345=0.42; F/f3=0.707; F/f4=−0.772; F/f5=0.408; f345/f12=−0.485; f4/f3=−0.915.

With the aforementioned design, the first lens L1, the second lens L2, the third lens L3, the fourth lens L4, and the fifth lens L5 satisfy the aforementioned conditions (1) to (4) of the optical imaging lens 100.

Moreover, an aspheric surface contour shape Z of each of the object-side surface S1 of the first lens L1, the image-side surface S2 of the first lens L1, the object-side surface S3 of the second lens L2, the image-side surface S4 of the second lens L2, the object-side surface S6 of the third lens L3, the image-side surface S7 of the third lens L3, the object-side surface S8 of the fourth lens L4, the image-side surface S9 of the fourth lens L4, the object-side surface S10 of the fifth lens L5, and the image-side surface S11 of the fifth lens L5 of the optical imaging lens 100 according to the first embodiment could be obtained by following formula:

$$Z = \frac{c {h}^{2}}{1 + \sqrt{1 - ( 1 + k ) {c}^{2} {h}^{2}}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

wherein Z is aspheric surface contour shape; c is reciprocal of radius of curvature; h is half the off-axis height of the surface; k is conic constant; A4, A6, A8, A10, A12, A14, and A16 respectively represents different order coefficient of h.

The conic constant k of each of the object-side surface S1 of the first lens L1, the image-side surface S2 of the first lens L1, the object-side surface S3 of the second lens L2, the image-side surface S4 of the second lens L2, the object-side surface S6 of the third lens L3, the image-side surface S7 of the third lens L3, the object-side surface S8 of the fourth lens L4, the image-side surface S9 of the fourth lens L4, the object-side surface S10 of the fifth lens L5, and the image-side surface S 11 of the fifth lens L5 of the optical imaging lens 100 according to the first embodiment and the different order coefficient of A4, A6, A8, A10, A12, A14, and A16 are listed in following Table 2:

TABLE 2

| Surface | k | A4 | A6 | A8 | A10 | A12 | A14 | A16 |
|---|---|---|---|---|---|---|---|---|
| S1 | 9.0000E+01 | −1.7335E−18 | 7.9958E−19 | −3.7477E−22 | 0 | 0 | 0 | 0 |
| S2 | −5.5671E−01 | −6.7171E−02 | −2.1907E−02 | 6.6646E−03 | −1.3911E−02 | 0 | 0 | 0 |
| S3 | 6.8990E+00 | −1.1198E−01 | 2.1114E−02 | 9.7037E−03 | −8.1960E−03 | −1.1517E−03 | 1.6713E−04 | −8.8508E−06 |
| S4 | −9.4900E−01 | −6.0827E−02 | 3.4645E−02 | −1.9153E−02 | 4.5073E−03 | −5.8517E−05 | −4.0910E−05 | 4.6973E−06 |
| S6 | 7.1424E+00 | −1.5373E−01 | 4.8938E−01 | −9.5128E+00 | 6.9361E+01 | −2.7594E+02 | 5.5046E+02 | −4.4513E+02 |
| S7 | −3.3964E+00 | 3.2273E−01 | −2.9840E+00 | 1.0024E+01 | −2.4593E+01 | 3.9501E+01 | −3.9349E+01 | 1.7496E+01 |
| S8 | −5.3171E+00 | 4.2592E−01 | −3.0585E+00 | 8.6463E+00 | −1.5868E+01 | 1.5028E+01 | −6.9069E+00 | 1.2018E+00 |
| S9 | −3.1108E+01 | −4.4796E−03 | −3.5823E−01 | −2.2158E−01 | 3.4418E+00 | −7.9917E+00 | 7.7559E+00 | −2.7767E+00 |
| S10 | −3.0908E+00 | −3.4481E−02 | 6.3917E−02 | −3.5826E−01 | 8.4265E−01 | −9.5609E−01 | 4.0313E−01 | 0 |
| S11 | 9.0000E+01 | 2.3964E−01 | −1.0417E−01 | −1.2127E−01 | 1.3550E−01 | −4.2550E−02 | 2.2388E−03 | 0 |

Taking optical simulation data to verify the imaging quality of the optical imaging lens 100, wherein FIG. 1B a diagram showing the astigmatic field curves according to the first embodiment; FIG. 1C is a diagram showing the distortion according to the first embodiment; FIG. 1D is a diagram showing the longitudinal spherical aberration according to the first embodiment. In FIG. 1B, a curve S is data of a sagittal direction, and a curve T is data of a tangential direction. The graphics shown in FIG. 1C and FIG. 1D are within a standard range. In this way, the optical imaging lens 100 of the first embodiment could effectively enhance image quality and lower a distortion thereof.

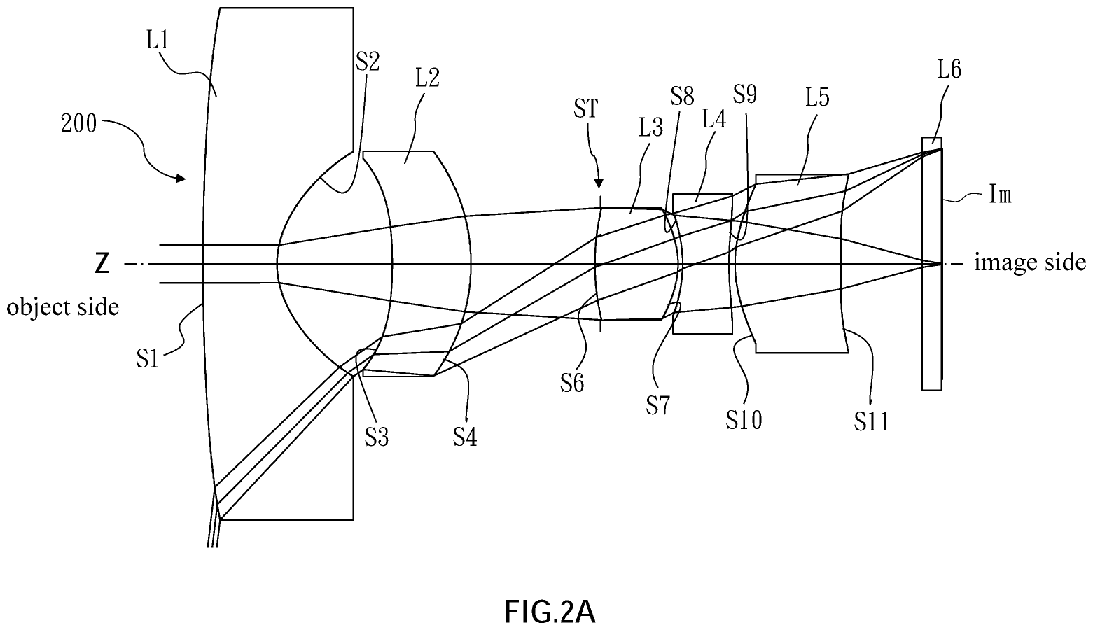

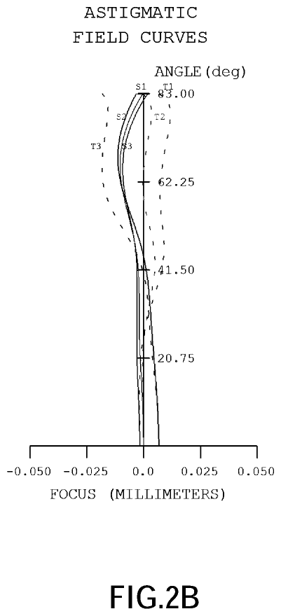

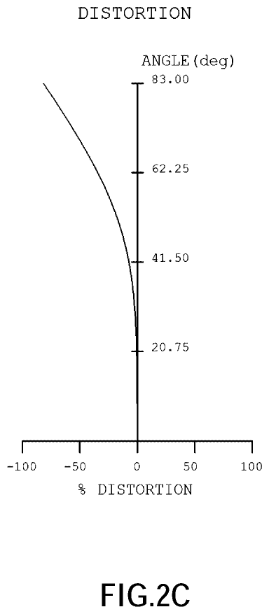

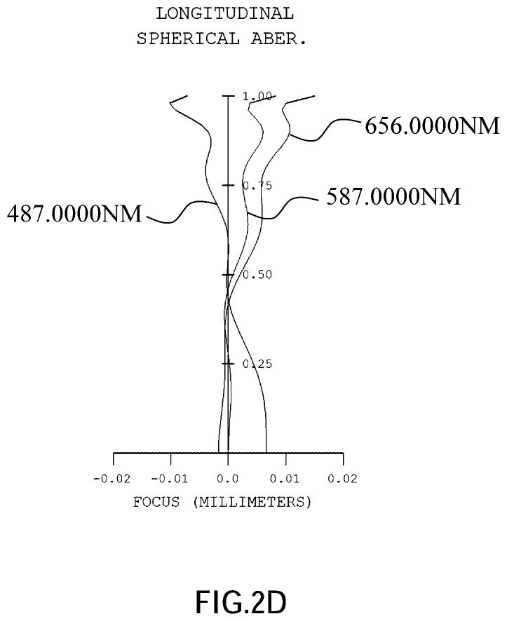

An optical imaging lens 200 according to a second embodiment of the present invention is illustrated in FIG. 2A, which includes, in order along an optical axis Z from an object side to an image side, a first lens L1, a second lens L2, an aperture ST, a third lens L3, a fourth lens L4, and a fifth lens L5.

The first lens L1 is a negative meniscus with negative refractive power, wherein an object-side surface S1 of the first lens L1 is a convex surface that is slightly convex toward the object side, and an image-side surface S2 of the first lens L1 is a concave surface that is arc-shaped. In the current embodiment, a part of a surface of the first lens L1 toward the image side is recessed to form the image-side surface S2, and the optical axis Z passes through both the object-side surface S1 and the image-side surface S2. The object-side surface S1 is an aspheric surface, the image-side surface S2 is an aspheric surface, or both of the object-side surface S1 and the image-side surface S2 of the first lens L1 are aspheric surfaces. In the current embodiment, both of the object-side surface S1 and the image-side surface S2 of the first lens L1 are aspheric surfaces.

The second lens L2 is a positive meniscus with a positive refractive power, wherein an object-side surface S3 of the second lens L2 is a concave surface that is meniscus shaped, and an image-side surface S4 of the second lens L2 is a convex surface. The object-side surface S3 is an aspheric surface, the image-side surface S4 is an aspheric surface, or both of the object-side surface S3 and the image-side surface S4 of the second lens L2 are aspheric surfaces. In the current embodiment, both of the object-side surface S3 and the image-side surface S4 of the second lens L2 are aspheric surfaces.

The third lens L3 is a biconvex lens with positive refractive power (i.e., object-side surface S6 of the third lens L3 and an image-side surface S7 thereof are convex surfaces). The object-side surface S6 of the third lens L3 is closer to the aperture ST than the image-side surface S4 of the second lens L2. The object-side surface S6 is an aspheric surface, the image-side surface S7 is an aspheric surface, or both of the object-side surface S6 and the image-side surface S7 of the third lens L3 are aspheric surfaces. In the current embodiment, both of the object-side surface S6 and the image-side surface S7 of the third lens L3 are aspheric surfaces.

The fourth lens L4 is a biconcave lens with negative refractive power (i.e., an object-side surface S8 of the fourth lens L4 and an image-side surface S9 thereof are concave surfaces). The object-side surface S8 is an aspheric surface, the image-side surface S9 is an aspheric surface, or both of the object-side surface S8 and the image-side surface S9 of the fourth lens L4 are aspheric surfaces. In the current embodiment, both of the object-side surface S8 and the image-side surface S9 of the fourth lens L4 are aspheric surfaces.

The fifth lens L5 has positive refractive power, wherein an object-side surface S10 of the fifth lens L5 is a convex surface, and an image-side surface S11 of the fifth lens L5 is a concave surface. The object-side surface S10 is an aspheric surface, the image-side surface S11 is an aspheric surface, or both of the object-side surface S10 and the image-side surface S1 of the fifth lens L5 are aspheric surfaces. In the current embodiment, both of the object-side surface S10 and the image-side surface S11 of the fifth lens L5 are aspheric surfaces.

Additionally, the optical imaging lens 200 further includes an infrared filter L6 disposed at a side of the image-side surface S11 of the fifth lens L5 and located between the fifth lens L5 and an image plane Im of the optical imaging lens 200.

In order to keep the optical imaging lens 200 in good optical performance and high imaging quality, the optical imaging lens 200 further satisfies:

0.1<F/TTL<0.15; (1)

−0.25<F/f12<−0.15; −0.68<F/f1<−0.45; 0.1<F/f2<0.2; (2)

0.35<F/f345<0.5; 0.55<F/f3<0.85; −0.85<F/f4<−0.55; 0.35≤F/f5≤0.45; (3)

−0.55≤f345/f12≤−0.35; −1.5<f4/f3≤−0.85; (4)

wherein TTL is a total length of the optical imaging lens 200 (i.e., a distance on the optical axis Z from the object-side surface of the first lens to the image plane); F is a focal length of the optical imaging lens 200; f1 is a focal length of the first lens L1; f2 is a focal length of the second lens L2; f3 is a focal length of the third lens L3; f4 is a focal length of the fourth lens L4; f5 is a focal length of the fifth lens L5; f12 is a focal length of a combination of the first lens L1 and the second lens L2; f345 is a focal length of a combination of the third lens L3, the fourth lens L4, and the fifth lens L5.

Parameters of the optical imaging lens 200 of the second embodiment of the present invention are listed in the following Table 2, including the focal length (F) (also called an effective focal length (EFL)) of the optical imaging lens 200, a F-number (Fno), the maximal field of view (HFOV), TTL is a total length of the optical imaging lens 200; a radius of curvature (R) of each lens, a distance (D) between each surface and the next surface on the optical axis Z, a refractive index (Nd) of each lens, an Abbe number (Vd) of each lens, the focal length of each lens, and the cemented focal length of the second optical assembly C2 and the cemented focal length of the third optical assembly C3, wherein a unit of the focal length, the radius of curvature, and the distance is millimeter (mm). The data listed below are not a limitation of the present invention, wherein the parameters that could be appropriate changed by one with ordinary skill in the art after referring the present invention should still fall within the scope of the present invention.

TABLE 3
F = 0.81 mm; Fno = 2.03; HFOV = 166 deg; TTL = 8.0 mm; 1/2 Image height = 1.2 mm

| Surface | R (mm) | D (mm) | Nd | Vd | Focal length | Note |
|---|---|---|---|---|---|---|
| S1 | 25.596 | 0.80 | 1.69 | 54 | −1.31 | L1 |
| S2 | 0.865 | 1.25 | | | | |
| S3 | −4.362 | 0.85 | 1.64 | 23.5 | 4.86 | L2 |
| S4 | −1.964 | 1.40 | | | | |
| ST | | −0.06 | | | | Aperture |
| S6 | 2.335 | 0.90 | 1.525 | 56 | 1.22 | L3 |
| S7 | −0.771 | 0.05 | | | | |
| S8 | −1.201 | 0.50 | 1.64 | 23.5 | −1.22 | L4 |
| S9 | 2.682 | 0.07 | | | | |
| S10 | 1.247 | 1.14 | 1.525 | 56 | 2.32 | L5 |
| S11 | −49.275 | 1.69 | | | | |
| S12 | | 0.21 | 1.516 | 64 | | Infrared filter |
| S13 | | 0.00 | | | | |
| Im | 0 | 0 | | | | |

It can be seen from Table 3 that, in the second embodiment, the focal length (F) of the optical imaging lens 200 is 0.84 mm; the Fno of the optical imaging lens 200 is 2.05; the HFOV of the optical imaging lens 200 is 170 degrees; TTL of the optical imaging lens 200 is 8.0 mm; f1=−1.31 mm; f2=4.86 mm; f3=1.22 mm; f4=−1.22 mm; f5=2.32 mm; f12=−4.24 mm; f345=1.99 mm.

Additionally, based on the above detailed parameters, detailed values of the aforementioned conditional formula in the second embodiment are as follows: F/TTL=0.101; F/f12=−0.191; F/f1=−0.618; F/f2=0.166; F/f345=0.407; F/f3=0.663; F/f4=−0.663; F/f5=0.349; f345/f12=−0.469; f4/f3=−1.

With the aforementioned design, the first lens L1, the second lens L2, the third lens L3, the fourth lens L4, and the fifth lens L5 satisfy the aforementioned conditions (1) to (4) of the optical imaging lens 200.

Moreover, an aspheric surface contour shape Z of each of the object-side surface S1 of the first lens L1, the image-side surface S2 of the first lens L1, the object-side surface S3 of the second lens L2, the image-side surface S4 of the second lens L2, the object-side surface S6 of the third lens L3, the image-side surface S7 of the third lens L3, the object-side surface S8 of the fourth lens L4, the image-side surface S9 of the fourth lens L4, the object-side surface S10 of the fifth lens L5, and the image-side surface S11 of the fifth lens L5 of the optical imaging lens 200 according to the second embodiment could be obtained by following formula:

$$Z = \frac{c {h}^{2}}{1 + \sqrt{1 - ( 1 + k ) {c}^{2} {h}^{2}}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16}$$

wherein Z is aspheric surface contour shape; c is reciprocal of radius of curvature; h is half the off-axis height of the surface; k is conic constant; A4, A6, A8, A10, A12, A14, and A16 respectively represents different order coefficient of h.

The conic constant k of each of the object-side surface S1 of the first lens L1, the image-side surface S2 of the first lens L1, the object-side surface S3 of the second lens L2, the image-side surface S4 of the second lens L2, the object-side surface S6 of the third lens L3, the image-side surface S7 of the third lens L3, the object-side surface S8 of the fourth lens L4, the image-side surface S9 of the fourth lens L4, the object-side surface S10 of the fifth lens L5, and the image-side surface S11 of the fifth lens L5 of the optical imaging lens 200 according to the second embodiment and the different order coefficient of A4, A6, A8, A10, A12, A14, and A16 are listed in following Table 4:

TABLE 4

| Surface | k | A4 | A6 | A8 | A10 | A12 | A14 | A16 |
|---|---|---|---|---|---|---|---|---|
| S1 | 9.0000E+01 | −1.7335E−18 | 7.9958E−19 | −3.7477E−22 | 0 | 0 | 0 | 0 |
| S2 | −5.5671E−01 | −6.7171E−02 | −2.1907E−02 | 6.6646E−03 | −1.3911E−02 | 0 | 0 | 0 |
| S3 | 6.8990E+00 | −1.1198E−01 | 2.1114E−02 | 9.7037E−03 | −8.1960E−03 | −1.1517E−03 | 1.6713E−04 | −8.8508E−06 |
| S4 | −9.4900E−01 | −6.0827E−02 | 3.4645E−02 | −1.9153E−02 | 4.5073E−03 | −5.8517E−05 | −4.0910E−05 | 4.6973E−06 |
| S6 | 7.1424E+00 | −1.5373E−01 | 4.8938E−01 | −9.5128E+00 | 6.9361E+01 | −2.7594E+02 | 5.5046E+02 | −4.4513E+02 |
| S7 | −3.3964E+00 | 3.2273E−01 | −2.9840E+00 | 1.0024E+01 | −2.4593E+01 | 3.9501E+01 | −3.9349E+01 | 1.7496E+01 |
| S8 | −5.3171E+00 | 4.2592E−01 | −3.0585E+00 | 8.6463E+00 | −1.5868E+01 | 1.5028E+01 | −6.9069E+00 | 1.2018E+00 |
| S9 | −3.1108E+01 | −4.4796E−03 | −3.5823E−01 | −2.2158E−01 | 3.4418E+00 | −7.9917E+00 | 7.7559E+00 | −2.7767E+00 |
| S10 | −3.0908E+00 | −3.4481E−02 | 6.3917E−02 | −3.5826E−01 | 8.4265E−01 | −9.5609E−01 | 4.0313E−01 | 0 |
| S11 | 9.0000E+01 | 2.3964E−01 | −1.0417E−01 | −1.2127E−01 | 1.3550E−01 | −4.2550E−02 | 2.2388E−03 | 0 |

Taking optical simulation data to verify the imaging quality of the optical imaging lens 200, wherein FIG. 2B a diagram showing the astigmatic field curves according to the second embodiment; FIG. 2C is a diagram showing the distortion according to the second embodiment; FIG. 2D is a diagram showing the longitudinal spherical aberration according to the second embodiment. In FIG. 2B, a curve S is data of a sagittal direction, and a curve T is data of a tangential direction. The graphics shown in FIG. 2C and FIG. 2D are within a standard range. In this way, the optical imaging lens 200 of the second embodiment could effectively enhance image quality and lower a distortion thereof.

It must be pointed out that the embodiments described above are only some preferred embodiments of the present invention. It is noted that, the parameters listed in Tables are not a limitation of the present invention. All equivalent structures which employ the concepts disclosed in this specification and the appended claims should fall within the scope of the present invention.

What is claimed is:

1. An optical imaging lens, in order from an object side to an image side along an optical axis, comprising:
a first lens having negative refractive power, wherein an object-side surface of the first lens is a convex surface, and an image-side surface of the first lens is a concave surface; the object-side surface of the first lens and/or the image-side surface of the first lens are/is an aspheric surface;
a second lens having positive refractive power, wherein an object-side surface of the second lens is a concave surface, and an image-side surface of the second lens is a convex surface; the object-side surface of the second lens and/or the image-side surface of the second lens are/is an aspheric surface;
an aperture;
a third lens having positive refractive power, wherein the third lens is a biconvex lens; an object-side surface of the third lens and/or an image-side surface of the third lens are/is an aspheric surface;
a fourth lens having negative refractive power, wherein the fourth lens is a biconcave lens; an object-side surface of the fourth lens and/or an image-side surface of the fourth lens are/is an aspheric surface; and
a fifth lens having positive refractive power, wherein an object-side surface of the fifth lens is a convex surface, and an image-side surface of the fifth lens is a concave surface; the object-side surface of the fifth lens and/or the image-side surface of the fifth lens are/is an aspheric surface; the optical imaging lens satisfies: −0.55≤f345/f12≤−0.35, wherein f12 is a focal length of a combination of the first lens and the second lens, and f345 is a focal length of a combination of the third lens, the fourth lens, and the fifth lens.

2. The optical imaging lens as claimed in claim 1, wherein both of the object-side surface of the first lens and the image-side surface of the first lens are aspheric surfaces.

3. The optical imaging lens as claimed in claim 1, wherein both of the object-side surface of the second lens and the image-side surface of the second lens are aspheric surfaces.

4. The optical imaging lens as claimed in claim 1, wherein both of the object-side surface of the third lens and the image-side surface of the third lens are aspheric surfaces.

5. The optical imaging lens as claimed in claim 1, wherein both of the object-side surface of the fourth lens and the image-side surface of the fourth lens are aspheric surfaces.

6. The optical imaging lens as claimed in claim 1, wherein both of the object-side surface of the fifth lens and the image-side surface of the fifth lens are aspheric surfaces.

7. The optical imaging lens as claimed in claim 1, wherein the optical imaging lens satisfies: 0.1<F/TTL<0.15, wherein F is a focal length of the optical imaging lens, and TTL is a total length of the optical imaging lens.

8. The optical imaging lens as claimed in claim 1, wherein the optical imaging lens satisfies: −0.25<F/f12<−0.15, wherein F is a focal length of the optical imaging lens.

9. The optical imaging lens as claimed in claim 1, wherein the optical imaging lens satisfies: 0.35<F/f345<0.5, wherein F is a focal length of the optical imaging lens.

10. The optical imaging lens as claimed in claim 1, wherein the optical imaging lens satisfies: −0.68<F/f1<−0.45, wherein F is a focal length of the optical imaging lens, and f1 is a focal length of the first lens.

11. The optical imaging lens as claimed in claim 1, wherein the optical imaging lens satisfies: 0.1<F/f2<0.2, wherein F is a focal length of the optical imaging lens, and f2 is a focal length of the second lens.

12. The optical imaging lens as claimed in claim 1, wherein the optical imaging lens satisfies: 0.55<F/f3<0.85, wherein F is a focal length of the optical imaging lens, and f3 is a focal length of the third lens.

13. The optical imaging lens as claimed in claim 1, wherein the optical imaging lens satisfies: −0.85<F/f4<−0.55, wherein F is a focal length of the optical imaging lens, and f4 is a focal length of the fourth lens.

14. The optical imaging lens as claimed in claim 1, wherein the optical imaging lens satisfies: 0.3≤F/f5≤0.45, wherein F is a focal length of the optical imaging lens, and f5 is a focal length of the fifth lens.

15. The optical imaging lens as claimed in claim 1, wherein the optical imaging lens satisfies: −1.5<f4/f3≤−0.85, wherein f4 is a focal length of the fourth lens, and f3 is a focal length of the third lens.
